(19) United States
(12) Patent Application Publication
(10) Pub. No.: US 2018/0260736 A1
(43) Pub. Date: Sep. 13, 2018

(54) CROSS-OPTIMIZATION PREDICTION FOR DELIVERING CONTENT

(71) Applicant: Facebook, Inc., Menlo Park, CA (US)

(72) Inventors: Andrew Donald Yates, San Francisco, CA (US); Kurt Dodge Runke, Los Altos, CA (US); Gunjit Singh, San Francisco, CA (US)

(21) Appl. No.: 15/455,051

(22) Filed: Mar. 9, 2017

(51) Int. Cl. G06N 99/00; H04L 29/08

(52) U.S. Cl. CPC G06N 99/005; H04L 67/32

(57) ABSTRACT

When an opportunity arises to present a content item to a user, an online system delivers a content item to a user according to a first content delivery strategy associated with the content item. For the impression of the content item to the user, the online system tracks attributes associated with the first content delivery strategy. In addition to tracking the attributes associated with the first content delivery strategy, the online system also tracks attributes associated with at least one other content delivery strategy (a second content delivery strategy). The attributes tracked for the second content delivery strategy are used to train a machine learning model for the second content delivery strategy. The model is used to deliver the content item or other items according to the second content delivery strategy.

### BACKGROUND

This disclosure relates generally to online content distribution, and more specifically to using impressions of content items delivered with a certain objective to generate models for delivering content items with a different objective.

Some online systems generate user interest in the system by delivering content items to users. Typically, when an opportunity arises to present a content item to a user, multiple candidate content items are identified. A score generated for each candidate content item is used to select the content item to present to the user. For a candidate content item, the score may be determined, for example, based on a prediction model that determines a likelihood that a user will perform a certain event based on being presented with the content item (e.g., the user selecting the content item). In order for the prediction model to be able to determine this likelihood, the model is trained using training examples created from previous impressions of the content item.

However, when first creating the model to predict whether the event will occur, there are no examples or not very many examples for training the model. Hence, initially the model may inaccurately predict that a user will perform an event until sufficient examples are generated for the model. Moreover, the event that the model is predicting may not happen often. As a result, to make an accurate prediction, it may take a long time to have enough positive examples for training the model.

Additionally, based on the training, the model will identify characteristics of users that are likely to perform the event. Hence, scores for presenting to users with those characteristics will typically be high and scores for presenting to users that do not have those characteristics will be low. However, there may be other users with different characteristics than those identified by the model that are likely to perform the event. The model may not have learned about the other users because no training examples were presented to the model for the other users. Since the model will always provide a low score for presenting the content to these other users, the content item associated with the model will not be presented to the other users even though it is relevant for those other users.

### SUMMARY

An online system provides content to users. When an opportunity arises to present a content item to a user, the online system delivers a content item to a user according to a first content delivery strategy associated with the content item. For example, the first content delivery strategy of the content item may be to remind a broad range of users about a brand or to show the content item to users that are likely to select the content item (e.g., click on the content item). For the impression of the content item to the user, the online system tracks attributes associated with the first content delivery strategy. Assuming for example that the first content delivery strategy is to present the content item to users that are likely to select the content item, a tracked attribute may be whether the user selected the content item.

In addition to tracking the attributes associated with the first content delivery strategy, the online system also tracks attributes associated with at least one other content delivery strategy (a second content delivery strategy). The attributes tracked for the second content delivery strategy allow the impression to be used to train a machine learning model for the second content delivery strategy. The model is used to deliver the content item or other items according to the second content delivery strategy. If attributes associated with other content delivery strategies are tracked for the impression (e.g., attributes associated with a third and fourth content delivery strategy), the impression can be used to train additional machine learning models for delivering items according to the other strategies.

Continuing with the example where the first content delivery strategy is to present the content item to users that are likely to select the content item, the second content delivery strategy is to present the content item to users that are likely to take an action such as making a purchase based on the content item. When the content item is delivered to the user, in addition to the tracking the attribute of whether the user selected the content item, the online system also tracks the attribute of whether the user made a purchase from an online retailer associated with the content item. Whether the user made a purchase is not an attribute that needs to be tracked for the first content delivery strategy, but by tracking this attribute a training example can be generated to train a machine learning model to predict whether a user is likely to make a purchase. The model can then be used to deliver the content item to users that are likely to make a purchase.

### BRIEF DESCRIPTION OF THE DRAWINGS

FIG. 1 is a block diagram illustrating operations performed by an online system and a client device in delivering a content item to a user, in accordance with an embodiment.

FIG. 2 is a block diagram of a system environment in which the online system operates, in accordance with an embodiment.

FIG. 3 is a block diagram of the online system, in accordance with an embodiment.

FIG. 4 is a flowchart illustrating a process for providing content items to a client device, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

The figures use like reference numerals to identify like elements. A letter after a reference numeral, such as “104A,” indicates the text refers specifically to the element having that particular reference numeral. A reference numeral in the text without a following letter, such as “104,” refers to any or all of the elements in the figures bearing that reference numeral (e.g., “104” in the text refers to reference numerals “104A,” “104B” and/or “104C” in the figures).

### DETAILED DESCRIPTION

### Overview

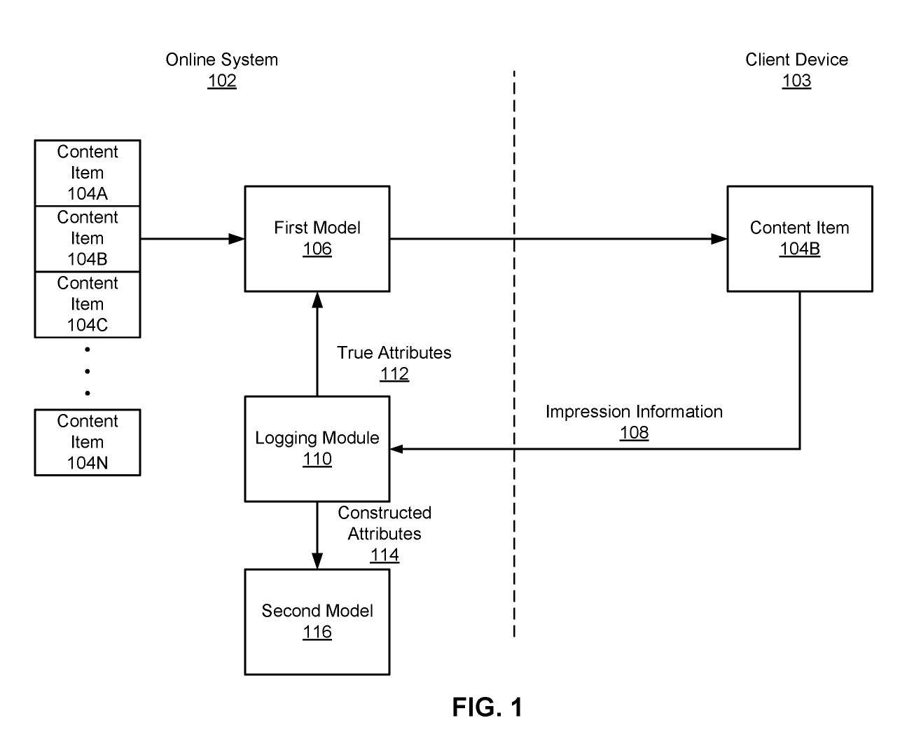

FIG. 1 is a block diagram illustrating operations performed by an online system 102 (e.g., a social networking system) and a client device 103 in delivering a content item to a user, in accordance with an embodiment. The online system 102 provides content to users (e.g., social networking content and advertisements). When an opportunity arises to present a content item (e.g., an advertisement) to a user, the online system 102 identifies multiple content items as candidates for presenting to the user. In this example, the online system 102 identifies content items 104A-104N. A bid/score is determined for each content item 104 and the content item with the highest bid is selected.

For content item 104B, the online system 102 uses a first model 106 to determine the bid for content item 104B. The first model 106 determines a likelihood that the user will perform a first event responsive to being presented content item 104B. The first event may be, for example, a user accessing a website associated with the content provider through the content item 104B. The likelihood determined by the first model 106 is input by the online system 102 into a function to determine the bid for the content item 104B, where the higher the likelihood that the user will perform the first type of event, the higher the bid. Hence, based on the first model 106 and the function, the online system 102 is optimized to present the content item 104B to users that are likely to perform the first type of event. Delivering the content item 104B to users that are likely to perform the first type of event is the content delivery strategy of the content item 104B.

In this example, the bid determined for the content item 104B based on the first model 106 is the highest bid among the content items 104. As a result, the online system 102 transmits the content item 104B to the client device 103 and the client device 103 displays the content item 104B to the user. A logging module 110 of the online system 102 creates a record for the impression of the content item 104B and includes in the record information associated with the impression. The information included in the record includes information used by the first model 106 to determine the likelihood, information used to calculate the bid, information about the user and the opportunity, etc.

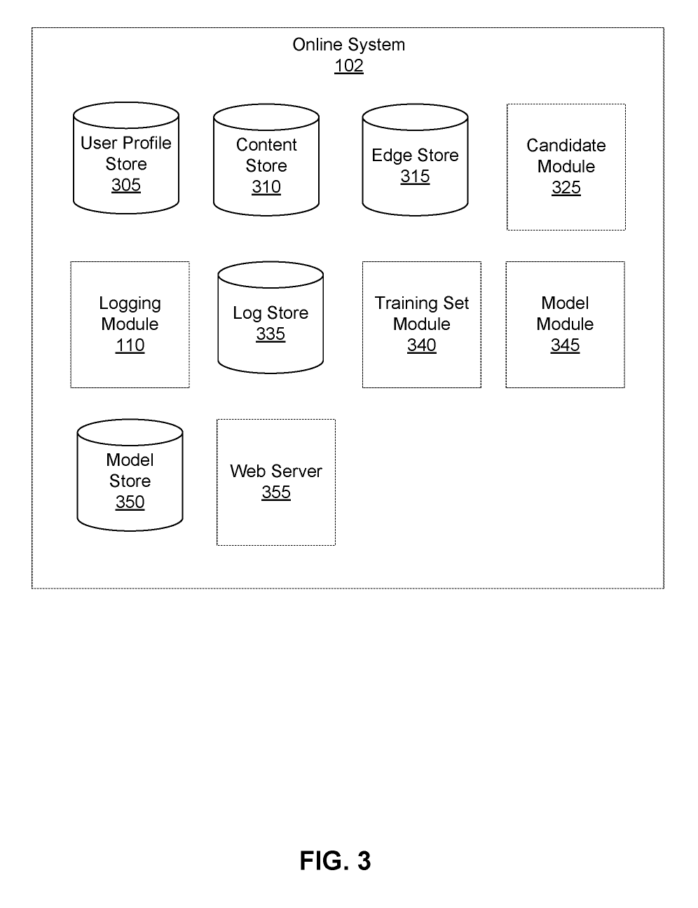

Additionally, the logging module 110 includes in the record impression information 108 received from the client device 103 that is associated with the presentation of the content item 104B to the user. The impression information 108 received includes one or more true attributes 112 and one or more constructed attributes 114. The true attributes 112 are information associated with the content delivery strategy of delivering the content item 104B to users that are likely to perform the first event (e.g., information used in optimizing for the first type of event to occur). True attributes 114 may include features used in determining to present a content item (in this example content item 104B) according to the content deliver strategy and events that occur after presentation of the content item that are associated with the content delivery strategy. For example, a true attribute 112 received from the client device 103 may be whether the user performed the first event after being presented the content item 104B. As illustrated by FIG. 3, true attributes 112 along with the additional information from the record can be used as a training example to further train the first model 106.

The constructed attributes 114 are information associated with one or more other content delivery strategies (e.g., information used in optimizing for other types of events to occur). Constructed attributes may include features generated at delivery time but not used in determining whether to present a content item (in this example content item 104B). Constructed attributes may also include events that occur after presentation of the content item that are associated with a content delivery strategy that is different from the strategy used to deliver the content item.

In this example, the content item 104B is delivered by the online system 102 for the purpose of the first event occurring, but the online system 102 also tracks other attributes as if the content item was being delivered for a different purpose (i.e., as if the content item was delivered according to a different content delivery strategy). The other attributes are the constructed attributes 114. As illustrated by FIG. 3, the constructed attributes 114 can be used to train a second model 116 for predicting whether a second type of event will occur and the second model 116 can be used to deliver the content item according to a different content delivery strategy. By tracking the constructed attributes 114 in addition to the true attributes 112, the presentation of the content item 104B to the user of the client device 103 can be used to train the first model 106 as well as the second model 116.

As an example, assume that based on the first model 106, the online system 102 delivers the content item 104B according a content delivery strategy that comprises delivering the content item 104B to users that are likely to access a website through the content item 104B. When the content item 104B is delivered to the user of the client device 103, the logging module 110 will record as a true attribute 112 whether the user accessed the website through the content item 104B. In addition, the logging module 110 will record as a constructed attribute 114 whether the user placed an item in a virtual cart on the website. A training example can be created by the online system 102 that includes information of the user and the true attribute 112 (whether the user accessed the website) and the training example can be used to further train the first model 106.

There is generally no use for the constructed attribute 114 (whether the user placed an item in a virtual cart) in training the first model 106. Therefore, the constructed attribute 114 is typically not included in the training example used to train the first model 106. However, to train the second model 116 to determine a likelihood that a user will place an item in a virtual cart, the online system 102 replaces the true attribute 112 in the training example with the constructed attribute 114 to create a new training example. The new training example with the constructed attribute 114 can be used to train the second model 116.

If the content provider request that the content item 104B be delivered for purpose of the second event occurring, the online system 102 already has the second model 116 for delivering the content item 104 to users that are likely to perform the second event. From the start, the second model 116 will be fairly accurate in predicting whether a user is likely to perform the second event since it has been trained using the impressions associated with the first model 106. In contrast, if the second model 116 had not been trained using those impressions, the online system 102 would be starting from scratch with the second model 116 when the content provider makes the request and the initial predictions by the second model 116 are likely to be inaccurate.

Additionally, if the second event that the second model 116 is predicting does not happen often, there will not be a large amount of training examples that can be generated from use of the second model 116. Due to the lack of training examples, the accuracy of the second model 116 will suffer. However, by tracking the second event for impressions associated with the first model 106 and for other impressions, the online system 102 is able to generate more training examples for the second model 116 and as a result the accuracy of the second model 116 will improve.

As another example, assume that the second model 116 learns based on a set of training examples that users with certain characteristics are likely to perform the second event. As a result, based on the second model 116 the online system 102 is biased to delivering content to users with the certain characteristics. However, the impressions of the content item 104B using the first model 106 may be to users with different characteristics or to a wide range of users. By using the impressions of the content item 104B to train the second model 116, the second model 116 may learn of new types of users that are likely to perform the second event.

In some embodiments, instead of the first model, the content items may be delivered according to a CPM (cost per 1,000 impressions or cost per mille) content delivery strategy, or other suitable content delivery strategies. For example, CPM delivery may produce less biased training examples to train an oCPM (optimized cost per mille) model. This allows the oCPM model to learn from promising but dissimilar impression opportunities that are corresponding to content items delivered by the CPM, not by the oCPM.

In some embodiments, a single training example generated by logging the appropriate sets of constructed attributes may be used to train additional models, including the second model 116.

### System Architecture

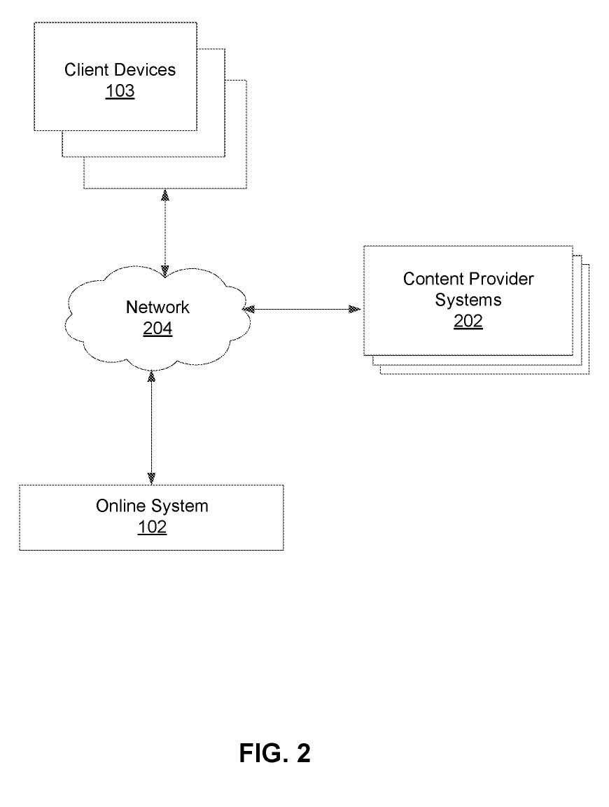

FIG. 2 is a block diagram of a system environment 200 in which the online system 102 operates, in accordance with an embodiment. In the embodiment shown in FIG. 2, the system environment 200 includes multiple client devices 103, multiple content provider system 202, and the online system 102 connected through a network 204. In alternative embodiments, different and/or additional components may be included in the system environment 200.

The network 204 represents communications pathways between the client devices 103, the content provider systems 202, and the online system 102. The network 204 may comprise any combination of local area and/or wide area networks, using both wired and/or wireless communication systems. In one embodiment, the network 204 uses standard communications technologies and/or protocols. For example, the network 204 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 204 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 204 may be represented using any suitable format, such as hypertext markup language (HTML) or extensible markup language (XML). In some embodiments, all or some of the communication links of the network 204 may be encrypted using any suitable technique or techniques.

The client devices 103 are one or more computing devices capable of receiving user input as well as transmitting and/or receiving data via the network 204. In one embodiment, a client device 103 is a conventional computer system, such as a desktop or laptop computer. Alternatively, a client device 103 may be a device having computer functionality, such as a personal digital assistant (PDA), a mobile telephone, a smartphone or another suitable device. A client device 103 is configured to communicate via the network 204. In one embodiment, a client device 103 executes an application allowing a user of the client device 103 to interact with the online system 102. For example, a client device 103 executes a browser application to enable interaction between the client device 103 and the online system 102 via the network 204. In another embodiment, a client device 103 interacts with the online system 102 through an application programming interface (API) running on a native operating system of the client device 103, such as IOS® or ANDROID™.

A user may communicate with the online system 102 through a client device 103 to provide and obtain content from the online system 102. For example, the content obtained from the online system 102 may be social networking content such as a profile page and content shared by connections of the user (e.g., comments, posts, messages, images, links, etc.). Content obtained from the online system 102 may also include advertisements.

A content provider system 202 is a computer system of a content provider that provides content to the online system 102 for distribution to users of the online system 102. Examples of such content include advertisements, stories, images, and videos. When providing a content item to the online system 102 for distribution to users, the content provider system 202 may provide information that describes the context in which the online system 102 should provide the content item to users, such as properties of the users to whom the content item should be provided (e.g., age, gender, or particular interests), or properties of webpages in which the content item should be included (e.g., the topic(s) of the pages).

The online system 102 is a computer system that shares content with client devices 103. In one embodiment, the online system 102 is an online system that provides social networking content to users. However, in other embodiments the online system 102 is adapted to provide other types of content that is not social networking content. A content provider system 202 may request that online system 102 run campaigns to have content items (e.g., advertisements) distributed to users of the online system 102. The online system 102 receives from the content provider system 202 a content item along with information indicating a content delivery strategy that is to be used for the distribution of the content item to users. A content delivery strategy may be, for example, that the content item be provided to a wide range of users to promote a brand/product/service. As another example, the content delivery strategy may be that the content item be presented to users that are likely to perform a certain event upon being presented with the content item, such as selecting (e.g., clicking on) the content item, visiting a website, placing an item in a virtual shopping cart, or making a purchase.

When a content item is delivered by the online system 102 to a client device 103 according to a content delivery strategy, the online system 102 tracks attributes as if the content item was delivered according one or more different content delivery strategies. The tracking of the attributes allows the online system 102 to use the impression of the content item to generate training examples that can be used to train a wide range of machine learning models for different content delivery strategies. The online system 102 is further described below in conjunction with FIG. 3.

### An Example of an Online System

FIG. 3 is a block diagram of the online system 102, in accordance with an embodiment. The online system 102 includes a user profile store 305, a content store 310, an edge store 315, a candidate module 325, logging module 110, a log store 335, a training set module 340, a model module 345, a model store 350, and a web server 355. In other embodiments, the online system 102 may include additional, fewer, or different components for various applications. Conventional components such as network interfaces, security functions, load balancers, failover servers, management and network operations consoles, and the like are not shown so as to not obscure the details of the system architecture.

Each user of the online system 102 is associated with a user profile, which is stored in the user profile store 305. A user profile includes declarative information about the user that was explicitly shared by the user and may also include profile information inferred by the online system 102. In one embodiment, a user profile includes multiple data fields, each describing one or more attributes of the corresponding user of the online system 102. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 102 displayed in an image. A user profile in the user profile store 305 may also maintain references to actions by the corresponding user performed on content items in the content store 310.

While user profiles in the user profile store 305 are frequently associated with individuals, allowing individuals to interact with each other via the online system 102, user profiles may also be stored for entities such as businesses or organizations. This allows an entity to establish a presence on the online system 102 for connecting and exchanging content with other online system users. The entity may post information about itself, about its products or provide other information to users of the online system 102 using a brand page associated with the entity's user profile. Other users of the online system 102 may connect to the brand page to receive information posted to the brand page or to receive information from the brand page. A user profile associated with the brand page may include information about the entity itself, providing users with background or informational data about the entity.

The content store 310 stores objects that each represent various types of content. Examples of content represented by an object include a page post, a status update, a photograph, a video, a link, a shared content item, an advertisement, a gaming application achievement, a check-in event at a local business, a brand page, or any other type of content. Online system users may create objects stored by the content store 310, such as status updates, photos tagged by users to be associated with other objects in the online system 102, events, groups or applications. In one embodiment, objects in the content store 310 represent single pieces of content, or content “items.” In some embodiments, a content item may be received by the online system 102 from a content provider system 202 for distribution to users. The content provider system 202 may also provide content constraints and indicate a content delivery strategy that is to be used to deliver the content item to users. Content constraints may include a budget for the content item, one or more time periods during which the content item can be displayed to users, and any other constraints affecting presentation of the content item. The content delivery strategy indicates a goal or a purpose for delivering the content item to users. For example, a content delivery strategy may be to present the content item to users that are likely to perform a certain event. As another example, the purpose of the content item may not be to get users to perform a certain event but rather to remind users about a brand, product, or service. Along with the content item, the content store 310 also stores the constraints and content delivery strategy associated with the content item. The content store 310 may also store with the content item information on a machine learning model stored in the model store 350 that is to be used to determine when to present the content item, a function used to compute a bid for the content item, and attributes to be tracked when the content item is presented to a user.

The edge store 315 stores information describing connections between users and other objects on the online system 102 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 102, such as expressing interest in a page on the online system 102, sharing a link with other users of the online system 102, and commenting on posts made by other users of the online system 102. Users and objects within the online system 102 can represented as nodes in a social graph that are connected by edges stored in the edge store 315.

In one embodiment, an edge may include various elements each representing characteristics of interactions between users, interactions between users and object, or interactions between objects. For example, elements included in an edge describe rate of interaction between two users, how recently two users have interacted with each other, the rate or amount of information retrieved by one user about an object, or the number and types of comments posted by a user about an object. The elements may also represent information describing a particular object or user. For example, an element may represent the level of interest that a user has in a particular topic, the rate at which the user logs into the online system 102, or information describing demographic information about a user. Each element may be associated with a source object or user, a target object or user, and an element value. An element may be specified as an expression based on values describing the source object or user, the target object or user, or interactions between the source object or user and target object or user; hence, an edge may be represented as one or more element expressions.

The edge store 315 also stores information about edges, such as affinity scores for objects, interests, and other users. Affinity scores, or “affinities,” may be computed by the online system 102 over time to approximate a user's affinity for an object, interest, and other users in the online system 102 based on the actions performed by the user. A user's affinity may be computed by the online system 102 over time to approximate a user's affinity for an object, interest, and other users in the online system 102 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 315, in one embodiment. Alternatively, each interaction between a user and a specific object is stored as a separate edge. In some embodiments, connections between users may be stored in the user profile store 305, or the user profile store 305 may access the edge store 315 to determine connections between users.

The candidate module 325 identifies a content item to be delivered to a client device 103 for presentation to a user. When an opportunity arises to present a content item to a user, the candidate module 325 identifies in the content store 310 content items that can be delivered to the user for the opportunity. The identified content items are referred to as candidate content items. In one embodiment, the candidate module 325 determines a bid for each candidate content item based on a function associated with the candidate content item. The function determines the bid for the candidate content item according to a content delivery strategy associated with the content item. A function associated with a candidate content item may use a value output by a machine learning model stored in the model store 350 for determining the bid. For example, if the content delivery strategy associated with the content item is to present the content item to users that are likely to make a purchase, a model associated with the content item may output a likelihood that the user will make a purchase upon being presented the content item. The likelihood is a value included in the function to determine the bid, where the more likely the user is to make a purchase, the higher the bid. The machine learning model may use information about the user and the opportunity to determine the output. Information about a user may include biographic, demographic, and other types of descriptive information, such as work experience, educational history, gender, hobbies or preferences, location and the like. The logging module 110 may extract information about a user from the user profile store 305. Historical statistics associated with the candidate content item may be used by the model or function to determine the bid, such as the number of times the content item has been selected and/or presented, the bids associated with previous presentations of the content item, the amount of budget previously used by the content item, or the percentage of times the content item has been interacted with by users.

Based on the bid determined for each candidate content item, the candidate module 325 selects a content item to deliver to the client device 103 of the user. In one embodiment, the candidate module 325 selects one or more content items with the highest bids among the candidates. The candidate module 325 transmits the selected one or more content items to the client device 103 for presentation to the user. The selection and presentation of a content item to a user is referred to as an impression of the content item.

The logging module 110 creates a record for each impression of a content item. When a content item is transmitted to a client device 103 by the candidate module 325 for presentation to a user, the logging module 110 creates a record for the impression and stores the record in the log store 335 which includes records for different impressions. In the record the logging module 110 includes information used in determining to present the content item to the user, such as information about the user, information about the opportunity fulfilled by the impression, and information used in determining the bid for the content item.

Additionally, in the record the logging module 110 includes information associated with content delivery strategies. Some of this information may be received from the client device 103 and is related to the presentation of the content item to the user. The information associated with content delivery strategies may include true attributes and constructed attributes. True attributes are associated with the content delivery strategy used to deliver the content item to the user. True attributes include features used in determining to present the content item according to the content deliver strategy. True attributes also include events or actions that occur after presentation of the content item that are associated with the content delivery strategy. Constructed attributes are associated with other content delivery strategies different from the strategy used to deliver the content item to the user. Constructed attributes include features generated when determining whether to present the content item but not actually used in the determination of whether to present the content item. Constructed attributes also include events or actions that occur after presentation of the content item and are associated with a content delivery strategy that is different from the strategy used to deliver the content item.

For example, if the content delivery strategy is to deliver the content item to users that are likely to access a website associated with the content item, a true attribute included in the record by the logging module 110 may be whether the user accessed the website after being presented with the content item. However, the logging module 110 may also include in the record as a constructed attribute whether the user made a purchase through the web site. Whether the user made a purchase is not relevant to the strategy of delivering the content item to users that are likely to access the website, but the constructed attribute is relevant to at least one other content delivery strategy, such as delivering content to users that are likely to make a purchase. As discussed below with reference to the training set module 340, the constructed attributes can be used to generate a training example for training a model used for the other content delivery strategy.

In one embodiment, in order for the logging module 110 to receive from a client device 103 information related to the presentation of a content item, entities (e.g., content provider systems 202) place a tracking pixel or piece of HTML code on websites to monitor users visiting the websites that have not opted out of tracking. A tracking pixel might be included on various pages, including on a product page describing a product, on a shopping cart page that the user visits upon putting something into a shopping cart, on a checkout page that the user visits to checkout and purchase a product, etc. For example, a tracking pixel results in a transparent 1×1 image, an frame, or other suitable object being created for pages. When a user's browser loads a page having the tracking pixel, the tracking pixel results in the user's browser attempting to retrieve the content for that pixel, and the browser contacts the online system 102 to retrieve the content. The request sent to the online system 102, however, actually includes various data about the user's actions taken on the website. The website can control what data is sent to the online system 102. For example, the information sent to the online system 102 may include information about the page the user is loading (e.g., is it a product page, a shopping cart page, a checkout page, etc.), information on the page or about a product on the page of interest to the user (e.g., the SKU number of the product, the color, the size, the style, the current price, any discounts offered, the number of products requested, etc.), information about the user (e.g., a user identifier (UID) for the user, contact information for the user, etc.), and other data. In some embodiments, a cookie set by the online system 102 can also be retrieved by the online system 102, which can include various data about the user, such as the online systems' UID for the user, information about the client device 103 and the browser, such as the Internet Protocol (IP) address of the client device 103, among other data. Tracking can also be performed on mobile applications of content provider systems 202 by using a software development kit (SDK) of the online system 102 or via an application programming interface (API) of the online system 102 to track events (e.g., purchases) that occur by users on a content provider's app that are reported to the online system 102.

The training set module 340 generates training examples from records stored in the log store 335. In one embodiment, upon request from the model module 345, the training set module 340 generates trainings examples for a model. The model module 345 indicates in the request the content delivery strategy associated with the model. The training set module 340 identifies records in the log store 335 of impressions for which attributes (true or constructed attributes) associated with the content delivery strategy were tracked. The training set module 340 may limit the identified records based on the request from the model module 345 to be for impressions of a content item that is associated with the model or for impressions of content items of a content provider system 202 associated with the model. For example, if the model is used for delivering a certain content item of a content provider system 202, the training set module 340 may identify records in the log store 335 of impressions of the content item or may identify impressions of different content items of the content provider system 202.

For each identified record, the training set module 340 generates a training example from the record. To generate the training example, the training set module 340 determines from the record whether the impression was according to the same content delivery strategy as that of the model. If the impression was according to the same content delivery strategy, the training set module 340 generates the training example to include the true attributes of the record. In one embodiment, the training set module 340 includes other information from the record in the training example (e.g., information of the opportunity fulfilled by the impression and information of the user to whom the content item was presented) but does not include the constructed attributes of the record. The constructed attributes are not included because they are not associated with the content delivery strategy of the model.

If the impression was according to a different content delivery strategy than that of the model, the training set module 340 generates the training example to include the constructed attributes in the record that are associated with the content delivery strategy of the model. The training set module 340 includes other information from the record in the training example but does not include true attributes and constructed attributes associated with content delivery strategies that are different than that of the model.

In one embodiment, the training set module 340 labels a generated training example as a positive or negative example. A positive example indicates that an event associated the content delivery strategy of the model occurred based on the impression. A negative example indicates that the event associated the content delivery strategy of the model did not occur for the impression. For example, assume the content delivery strategy of the model is to deliver a content item to users that are likely to make a purchase from a merchant. If the training example indicates that a purchase was made based on the impression, the training set module 340 labels the training example as a positive example. However, if the training example indicates that a purchase was not made based on the impression, the training set module 340 labels the training example as a negative example.

The training set module 340 provides the generated training examples to the model module 345. In one embodiment, the training set module 340 may filter the training examples provided to the model module 345. For example, based on the request from the model module 345 the training set module 340 may filter the generated training examples to only provide positive examples. As another example, the training set module 340 filters the generated training examples to provide the same number of positive and negative examples.

The model module 345 trains a machine learning model using training examples from the training set module 340. In some embodiments, the model module 345 updates a trained model using recent impressions. The trained model predicts a likelihood that an event will occur and the prediction is used to deliver a content item according to a content delivery strategy. For example, the trained model may have been trained using previous training examples to predict the likelihood that a user will select a content item and the trained model is used by the candidate module 325 to present the content item to users that are likely to select the content item. The model module 345 requests from the training set module 340 training examples based on recent impressions for which attributes associated with the content delivery strategy were tracked. Based on the training examples received from the training set module 340, the model module 345 updates the model. For example, the model module 345 may update weights of the trained model using new training examples from the training set module 340.

In some embodiments, the model module 345 trains new models. For example, the model module 345 may train a new model if a content provider system 202/administrator of the system 202 requests to deliver a content item according to a content delivery strategy that has not been previously used to deliver the content item. As another example, while delivering a content item according to one content delivery strategy (e.g., maximize selections of the content item), the model module 345 may train a new model for delivering the content item according to another content delivery strategy (e.g., to maximize purchases of a product). When the new model is sufficiently trained, the content provider system 202 is offered the opportunity to deliver the content item according to the other content delivery strategy. If the content provider system 202 requests to deliver the content item according to the other content delivery strategy, the candidate module 325 begins to use the new model to deliver the content item. To train a new model, the model module 345 requests from the training set module 340 training examples of impressions for which attributes associated with the content delivery strategy of the new model were tracked. Based on the training examples received from the training set module 340 the model module 345 trains the new model.

In some embodiments, the model module 345 trains a model based one or more training algorithms. Examples of training algorithms include, but are not limited to, gradient boosted decision trees (GBDT), SVM (support vector machine), neural networks, logistic regression, naïve Bayes, memory-based learning, random forests, decision trees, bagged trees, boosted trees, or boosted stumps. The trained models are stored in the model store 350.

The web server 355 links the online system 102 via a network 204 to the one or more client devices 103, as well as to the one or more content provider systems 202. The web server 355 serves web pages, as well as other web-related content, such as JAVA®, FLASH®, XML and so forth. The web server 355 may receive and route messages between the online system 102 and the client device 103, for example, instant messages, queued messages (e.g., email), text messages, short message service (SMS) messages, or messages sent using any other suitable messaging technique. A user may send a request to the web server 355 to upload information (e.g., images or videos) that are stored in the content store 310. Additionally, the web server 355 may provide application programming interface (API) functionality to send data directly to native client device operating systems, such as IOS®, ANDROID™, WEBOS® or RIM®.

An Example Providing Content Items to a Client Device using Cross-Optimization

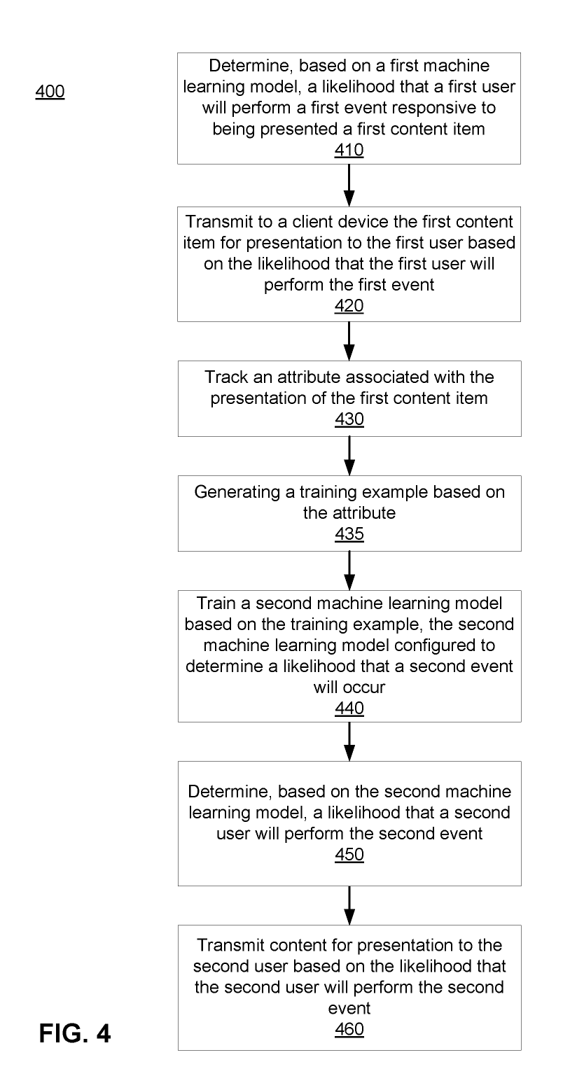

FIG. 4 is a flowchart illustrating a process for providing content items to a client device 103, in accordance with an embodiment. The process 400 may include different or additional steps than those described in conjunction with FIG. 4 in some embodiments or perform steps in different orders than the order described in conjunction with FIG. 4.

The online system 102 determines 410, based on a first machine learning model, a likelihood that a first user will perform a first event responsive to being presented a first content item. The online system 102 transmits 420 to a client device 103 the first content item for presentation to the first user based on the likelihood that the first user will perform the first event. The online system 102 tracks 430 an attribute associated with the presentation of the first content item. The attribute is not utilized by content delivery strategy used to deliver the first content item to the first user. The online system 102 generates 435 a training example based on the attribute.

The online system 102 trains 440 a second machine learning model based on the training example to determine a likelihood that a second event will occur. The online system 102 determines 450, based on the second machine learning model, a likelihood that a second user will perform the second event. The online system 102 transmits 460 content for presentation to the second user based on the likelihood that the second user will perform the second event.

### General

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a nontransitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a nontransitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computer system based on a first machine learning model, a likelihood that a first user will perform a first event responsive to being presented a first content item;
transmitting, by the computer system, to a first client device the first content item for presentation to the first user based on the likelihood that the first user will perform the first event;
tracking, by the computer system, an attribute associated with the presentation of the first content item to the first user;
generating, by the computer system, a training example based on the attribute;
training, by the computer system, a second machine learning model using the training example, the second machine learning model configured to determine a likelihood that a second event will occur;
determining, by the computer system, based on the second machine learning model, a likelihood that a second user will perform the second event; and
transmitting, by the computer system, content to a second client device for presentation to the second user based on the likelihood that the second user will perform the second event.

2. The method of claim 1, wherein the attribute tracked is whether the first user performed the second event after the presentation of the first content item to the first user.

3. The method of claim 1, wherein generating the training example further comprises:
tracking an additional attribute associated with the presentation of the first content item to the first user, the additional attribute indicating whether the first user performed the first event after presentation of the first content item;
generating the training example to include the attribute and not include the additional attribute.

4. The method of claim 1, further comprising:
generating an additional training example based on the presentation of the first content item to the first user, the additional training example not including the attribute; and
training the first machine learning model based on the additional training example.

5. The method of claim 1, further comprising:
responsive to training the second machine learning model, notifying an administrator associated with the first content item that the first content item is available for delivery to users for purpose of the second event occurring;
responsive to receiving a request from the administrator to deliver the first content item to users for purpose of the second event occurring, utilizing the second machine learning model to deliver the first content item to users.

6. The method of claim 1, wherein the content transmitted to a second client device is a second content item, prior to training the second machine learning model using the training example, the second content item delivered based on the second machine learning model to a first type of users and not a second type of users and responsive to training the second machine learning model using the training example, the second content item delivered based on the second machine learning model to the first type of users and the second type of users.

7. The method of claim 6, wherein the first user is included in the second type of users.

8. The method of claim 1, wherein the content transmitted for presentation to the second user is the first content item.

9. The method of claim 1, wherein the content transmitted for presentation to the second user is a second content item different than the first content item.

10. A computer-implemented method comprising:
delivering, by a computer system, a first content item to a first user based on a first content delivery strategy;
tracking, by the computer system, an attribute based on the delivering of the first content item to the first user, the attribute associated with a second content delivery strategy different than the first content delivery strategy;
generating, by the computer system, a training example based on the attribute;
training, by the computer system, a machine learning model using the training example, the machine learning model configured to determine a likelihood that an event associated with the second content delivery strategy will occur;
determining, by the computer system based on the machine learning model, a likelihood that a second user will perform the event; and
delivering, by the computer system, content to a second user based on the determined likelihood that the second user will perform the event and the second content delivery strategy.

11. The method of claim 10, wherein the first content delivery strategy comprises promoting a brand, product, or service associated with first content item.

12. The method of claim 10, wherein the first content delivery strategy comprises the first user performing an additional event based on the first content item.

13. The method of claim 10, wherein the attribute tracked is whether the first user performed the event after the presentation of the first content item to the first user.

14. The method of claim 10, wherein the first content delivery strategy comprises the first user performing an additional event based on the first content item and wherein delivering the first content item comprises:
determining based on an additional machine learning model a likelihood that the first user will perform the additional event responsive to being presented the first content item; and
delivering the first content item to the first user based on the determined likelihood that the first user will perform the additional event.

15. A non-transitory computer-readable medium comprising computer program instructions, the computer program instructions when executed by a computer processor causes the processor to perform the steps including:
determining, by a computer system based on a first machine learning model, a likelihood that a first user will perform a first event responsive to being presented a first content item;
transmitting, by the computer system, to a first client device the first content item for presentation to the first user based on the likelihood that the first user will perform the first event;
tracking, by the computer system, an attribute associated with the presentation of the first content item to the first user;
generating, by the computer system, a training example based on the attribute;
training, by the computer system, a second machine learning model using the training example, the second machine learning model configured to determine a likelihood that a second event will occur;
determining, by the computer system, based on the second machine learning model, a likelihood that a second user will perform the second event; and
transmitting, by the computer system, content to a second client device for presentation to the second user based on the likelihood that the second user will perform the second event.

16. The non-transitory computer-readable storage medium of claim 15, wherein the attribute tracked is whether the first user performed the second event after the presentation of the first content item to the first user.

17. The non-transitory computer-readable storage medium of claim 15, wherein generating the training example further comprises:
tracking an additional attribute associated with the presentation of the first content item to the first user, the additional attribute indicating whether the first user performed the first event after presentation of the first content item;
generating the training example to include the attribute and not include the additional attribute.

18. The non-transitory computer-readable storage medium of claim 15, further comprising:
generating an additional training example based on the presentation of the first content item to the first user, the additional training example not including the attribute; and
training the first machine learning model based on the additional training example.

19. The non-transitory computer-readable storage medium of claim 15, further comprising:
responsive to training the second machine learning model, notifying an administrator associated with the first content item that the first content item is available for delivery to users for purpose of the second event occurring;
responsive to receiving a request from the administrator to deliver the first content item to users for purpose of the second event occurring, utilizing the second machine learning model to deliver the first content item to users.

20. The non-transitory computer-readable storage medium of claim 15, wherein the content transmitted to a second client device is a second content item, prior to training the second machine learning model using the training example, the second content item delivered based on the second machine learning model to a first type of users and not a second type of users and responsive to training the second machine learning model using the training example, the second content item delivered based on the second machine learning model to the first type of users and the second type of users.
